(19) United States
(12) Patent Application Publication
(10) Pub. No.: US 2002/0052186 A1
(43) Pub. Date: May 2, 2002

(54) Low swing communication system

(76) Inventors: Alexander Roger Deas, Edinburgh (GB); Vasily Grigorievich Atyunin, Saint Petersburg (RU)

Correspondence Address: DEAS, Alexander, Roger, Office 501, 58, Moika Embankment, St. Petersburg, 190000, RU

(21) Appl. No.: 09/985,725

(22) Filed: Nov. 6, 2001

Related U.S. Application Data
(60) Provisional application No. 60/244,178, filed on Oct. 31, 2000.

(51) Int. Cl. H04B 17/00

(52) U.S. Cl. 455/226.1; 455/226.3; 455/296

(57) ABSTRACT

Low swing communication system wherein the output driver's signal is used to adjust the driver's swing to the receiver's parameters, in particular, the hysteresis at the receiver. The receiver generates a signal indicative of parameters bearing information on the maximum and minimum levels, e.g. voltage, current or other levels, to cause a signal to be received as a logical one and as a logical zero. This parameter signal may be digital, but is preferably a differential analogue signal. The parameters influence the signal swing of the driver.

### BACKROUND OF THE INVENTION

1. Field of the invention

The present invention relates generally to communication systems and, more particularly, to transmitting and receiving circuits for driving data over a communication cable.

2. Description of the Related Art

Contemporary high speed communication systems transmit a signal down a line with a terminating voltage and terminating resistance, normally located near the receiver. The effect of the transmitter is to send a fully saturated digital signal into the transmission line at the same impedance as the line itself such that any reflections from impedance anomalies in the line do not cause further reflections from the transmitter. The receiver has a terminating load at the same impedance as the transmission line. The terminating resistances are arranged in very high speed systems to create a terminating voltage that is typically the median of the voltage value of the 1 and 0 of the digital signal.

When the operation of these systems is analysed in detail, it is apparent that the threshold is near but often not at the terminating voltage and that the hysteresis of the receiver is in the order of a few millivolts, even though the signal swing is typically one to three volts. This means that when the signal is transmitted, only one percent of the time taken to slew the signal from a 0 to a 1 is actually changing the value at the receiver.

One effective technique used to make communication systems run faster without such problems is to reduce the voltage swings below the full supply rails. Selected signals are operated in a “low voltage swing” manner in order to reduce power consumption and increase the performance of these devices. Low voltage swing signals typically represent digital data with a representative voltage that is less than the supply voltage (Vdd) level. Low swing voltage signals are typically generated in true/complement pairs, referred to as “differential” pairs. The prior art receivers operate by sensing the voltage differential between the true/complement pair to determine the logic level of the signal.

For example, a receiver circuitry may be powered by a Vdd supply voltage of 3.3 Volts. An associated pair of low voltage swing signals may use a voltage of 1.9 Volts to represent logic high data and 1.1 Volts to represent logic low data. Such low voltage swing signals can increase performance because the amount of time to generate a voltage differential of 0.8 Volts is significantly shorter than to transition that signal from 0 to 3.3 Volts.

This creates a new requirement for fast, low-swing data receivers and output drivers. While low voltage swing signals present the above benefits, they also add additional design requirements, whereby the performance of drive transistors can substantially vary depending on their operating temperature, supply voltage, the process used for manufacturing, etc.

Another important parameter influencing the transmitter's performance are the receiver's characteristics, in particular the ones that influence the signal swing of the driver. These parameters include, but are not limited to, the hysteresis of the receiver and reference voltage at the receiver and may vary based on the parameters used to fabricate the receiver. As those parameters change, or as temperature changes, the performance of the receiver correspondingly changes and influences the driver's characteristics that become unstable.

In communication circuits of the prior art, however, the parameters of a transmitter are typically selected with no regard to the requirements of a particular receiver but so as to provide, with substantial safety margin, compatibility with a wide range of receivers. This causes the increase in swing and power losses and the reduction of the communication speed.

The object of the invention is to reduce the voltage swing at the receiver, preferably to make it as close to the minimum as practical given the noise within the system, such that the transmitter can send more data than would be possible under the circumstances where time was spent slewing signals outside the hysteresis band of the receiver.

### BRIEF SUMMARY OF THE INVENTION

The present invention provides a communication system which avoids or at least alleviates the above mentioned disadvantages of the prior art.

According to one aspect of the present invention, a communication system comprises a driving circuit having a controlled output voltage levels and a receiving circuit having at least one channel for receiving a main signal, wherein the receiving circuit further provides a feedback to the driver to adjust the parameters of the driver to the receiver's characteristics.

The parameters of the driver may include maximum and minimum voltage or current levels.

Preferably, the feedback comprises at least one auxiliary channel. The auxiliary channel may transfer back to the driver an information from, for example, a ring oscillator circuit used for measuring the parameters of the main receiver. The ring oscillator circuit of the receiving device can be based on an additional receiver identical to the main receiver.

Preferably, the ring oscillator circuit of the receiver is connected to a low pass filter for selecting a voltage required for properly terminating the receiver. Preferably, the selected voltage after being filtered is used to set up the terminating voltage and reference voltage, as the incorrect terminating voltage increases swing and skew in the system.

Preferably, the ring oscillator circuit of the receiver is connected to a high pass filter as well. Preferably, the selected signal after being filtered is applied to an amplitude detector for getting information on the receiver hysteresis.

Any other means can be used to get the information on the transition voltage and hysteresis value of the receiver, say a of low pass filter and a peak detector.

Preferably, the driving circuit of the communication system comprises a pair of transistors and a respective pair of buffers.

In case it is undesirable to have an additional connections between the receiver and the driver, the driving circuit of the communication system may comprise it own copy of an auxiliary receiver, which is also identical to the main receiver, preferably in combination with a low pass filter, a high pass filter and an amplitude detector.

The combination of the above features enables transmission and reception of electronic communications orders of magnitude faster than is possible using prior art technique. This is particularly useful when combined with systems that minimise the skew of a high speed signal. In the case for example where the skew is maintained to +/−10 ps, the present invention would allow up to 50 Gbps to be transmitted per wire using the same implementation technology that is currently limited in operation to 500 Mbps.

In another aspect, the invention is, in a communication system, a receiver that generates a signal representing parameters bearing information on the maximum and minimum levels, preferably voltage levels, or, possibly, current levels in some current mode devices, that are needed to cause a signal to be received as a logical one and as a logical zero.

The signal generated by the receiver may be implemented in a digital signal, a single-ended signal, a differential analogue signal or another type of the signal.

According to still another aspect of the present invention, a method of high speed low swing communicating is proposed comprising the steps of:

providing negative and positive voltage or current levels at the driver for driving a communication circuit;

generating a signal at the receiver indicative of parameters bearing information on the maximum and minimum levels to cause a signal to be received as a logical one and as a logical zero;

wherein the output signal swing of the driver is adjusted using the signal generated by the receiver.

The maximum and minimum levels of the signal generated by the receiver may be voltage, current or other levels.

Preferably, the output swing of the driver is adjusted to the receiver's hysteresis. Preferably, the output swing shall exceed the hysteresis level, say, be twice as high as the hysteresis level.

Preferably, the method further comprises the use of another receiver to adjust the driver with respect to hysteresis, reference voltage, or a combination of both these features.

It shall be also appreciated that though the embodiments described hereinbelow explain the idea of the invention using a single ended signal, the signal generated by the receiver may be implemented as well in a differential analogue signal or a signal of another type.

### BRIEF DESCRIPTION OF THE SEVERAL VIEWS OF THE DRAWINGS

FIG. 1a is an example diagram of a preferred embodiment of a low swing communication circuit with a receiver according to the present invention.

FIG. 1b is a typical example of a simple low pas filter comprising a resistor, a capacitor, and an output buffer, which can be used in the present invention.

FIG. 1c is a typical example of a high pass filter which can be used in the present invention.

FIG. 2 is an example diagram of another embodiment of the low swing communication circuit according to the present invention.

FIG. 3 is a diagram illustrating the operation of a low swing communication circuit shown in FIG. 1a.

### DETAILED DESCRIPTION OF THE INVENTION

The present invention relates to a low swing communication system. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiment shown and described, but is to be accorded the widest scope consistent with the principles and novel features herein disclosed.

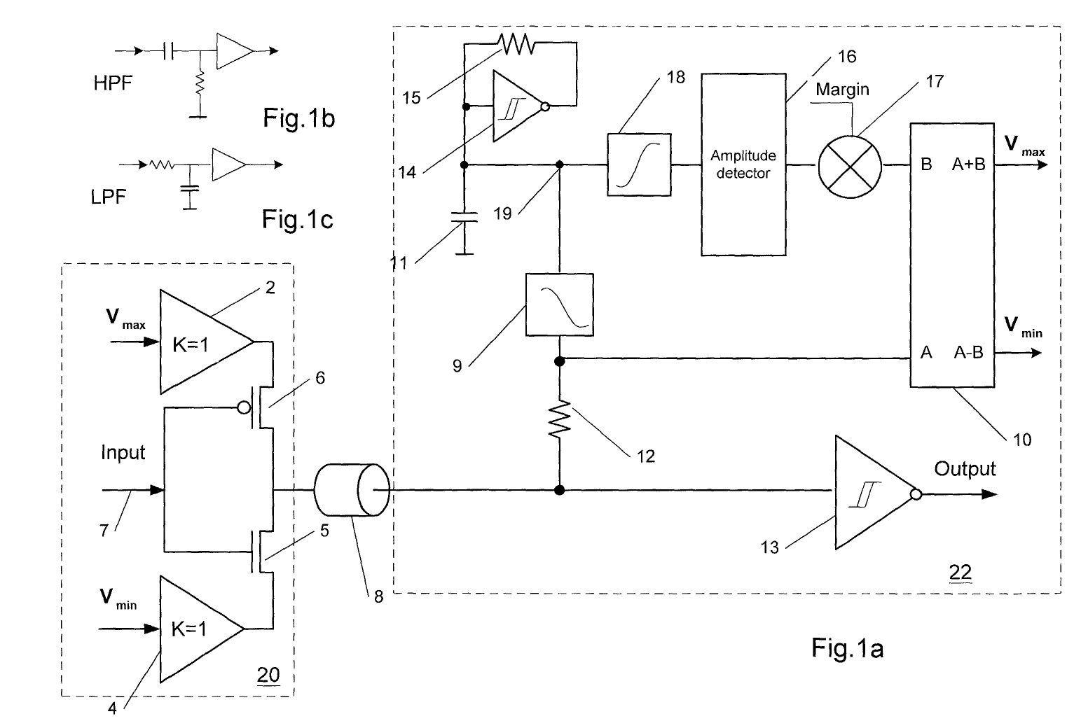

In FIG. 1a a low swing communication system according to the present invention is shown comprising a transmitter 20 driving a transmission line 8. The transmitter 20 comprises a complementary pair of transistors 5 and 6 powered by voltages Vₘᵢₙ and Vₘₐₓ respectively. The pair is controlled by an input signal 7. Vₘᵢₙ and Vₘₐₓ are provided by buffers 2 and 4. The transmission line 8 may be a cable, a trace on a circuit board or any other means of electrical connection between the transmitter 20 and a receiving circuit 22.

Further in FIG. 1a, the receiving circuit 22 comprises a receiver 13 having a certain degree of hysteresis and integrated with a circuit that generates a terminating voltage and also provides values of Vₘₐₓ and Vₘᵢₙ to the transmitter. This circuit comprises a ring oscillator formed by a receiver 14 identical to receiver 13, a resistor 15, and a capacitor 11.

Circuit 10 comprises an adder and subtractor and is used to get Vₘₐₓ and Vₘᵢₙ based on the threshold level and on the hysteresis value.

An example of a simple low pas filter is illustrated in FIG. 1b as comprising a resistor, a capacitor, and an output buffer. An example of high pass filter is presented in FIG. 1c.

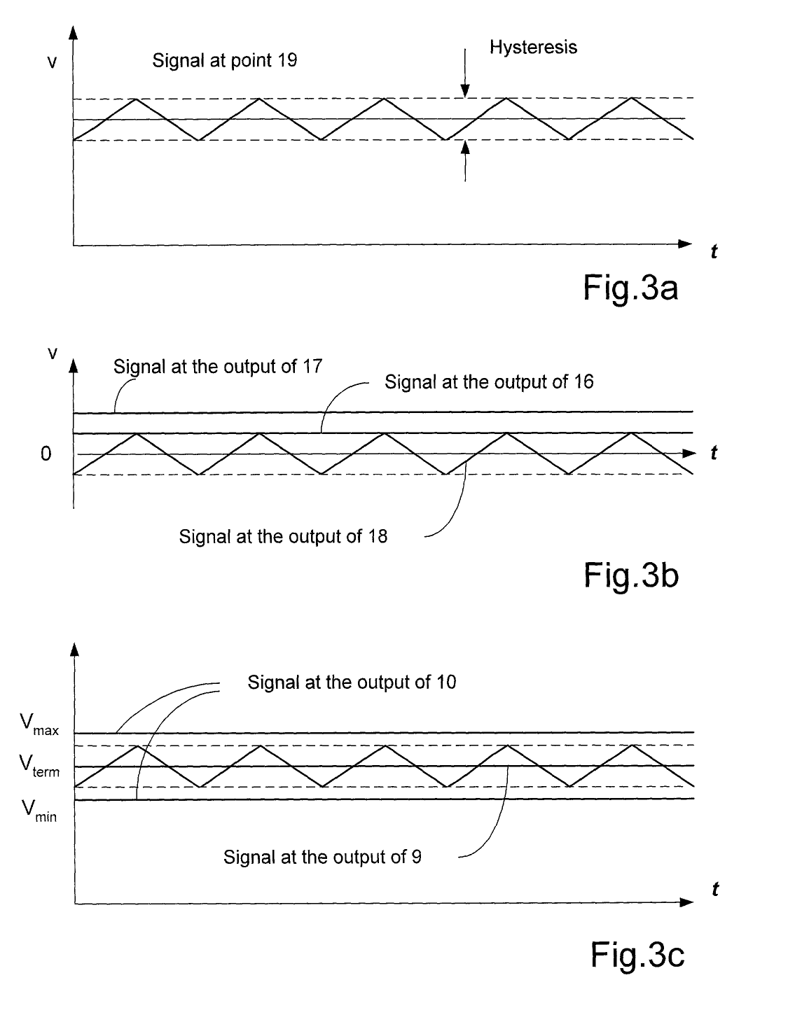

The system operates as follows. The ring oscillator will produce a waveform which is approximately triangular switching by the extent of its hysteresis around a transition voltage. At point 19, the signal generated by the ring oscillator represents, as shown in FIG. 3a, the hysteresis and the transition voltage Vtrans inherent to the receiver 14. The transition voltage selected by the low pass filter 9, as shown in FIG. 3c, is used for terminating the main receiver 13 by the resistor 12, whereas the information relating to hysteresis is obtained from the signal generated by the ring oscillator after selecting with a high pass filter 18 by amplitude detector 16, as shown in FIG. 3b.

The hysteresis value (signal at the output of 16) provided to the circuit 10 is increased by a required margin factor by multiplier 17 as shown as signal at the output of 17 in FIG. 3b. An amplifier can be used instead of the multiplier in order to get proper margin. The obtained Vₘₐₓ and Vₘᵢₙ shown in FIG. 3c as signals at the output of circuit 10 are supplied to the transmitter circuit 20. These signals reflect the amplitude the driver must drive when seen at the receiver 13 to create a logical one or zero.

At very high frequencies, transmission lines have losses which can be large. The amplification in the values of Vₘₐₓ and Vₘᵢₙ, either in the receiver, in the driver or independently, allows for this loss to be compensated.

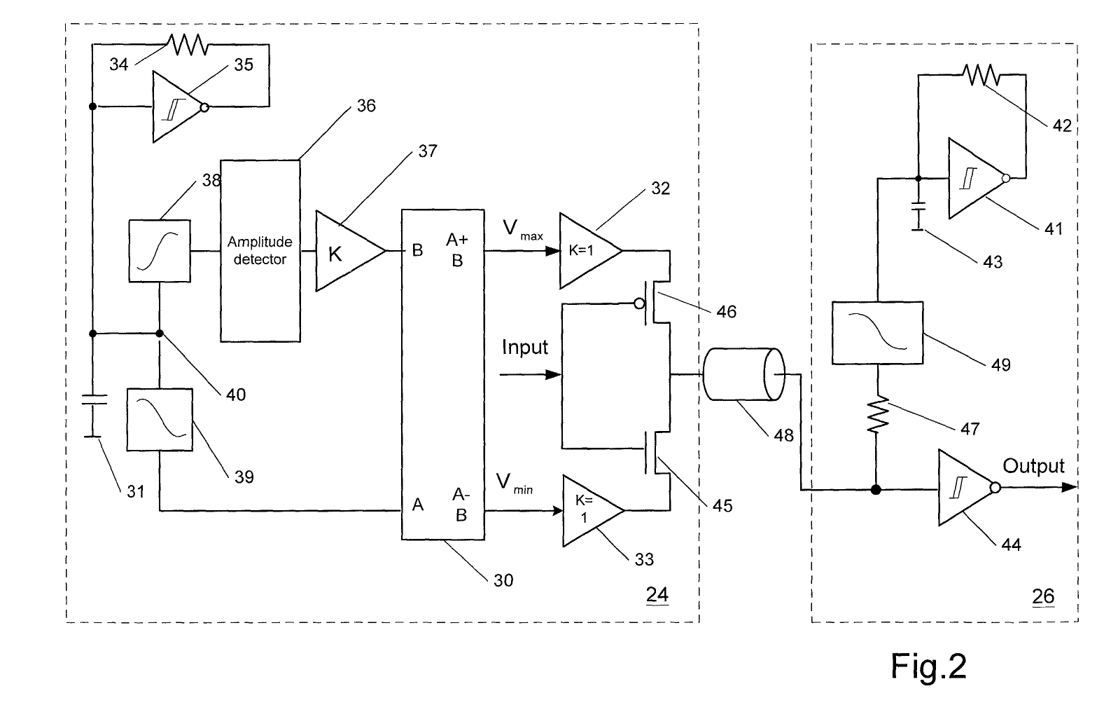

In a further embodiment shown in FIG. 2, no additional channels are required to get information from the receiver, preferably it is possible when identical chips are used on the driver and the receiver ends and they are in similar conditions in terms of supply voltage and temperature.

In FIG. 2 a low swing communication system according to the present invention is shown comprising a transmitter 24 driving a transmission line 48. The transmitter 24 comprises a complementary pair of transistors 45 and 46 powered by voltages Vₘᵢₙ and Vₘₐₓ respectively. The transmission line 48 may be a cable, a trace on a circuit board or any other means of electrical connection between the transmitter 24 and a receiving circuit 26.

In this embodiment, the transmitter comprises an auxiliary receiver 35 identical to the main receiver 44 having a certain degree of hysteresis. The auxiliary receiver 35 together with resistor 34 and capacitor 31 forms a ring oscillator which produces an approximately triangular waveform. At point 40, the signal generated by the ring oscillator represents the hysteresis and transition voltage inherent to the receiver 35. The transition voltage selected by the low pass filter 39 is used as an input A to the circuit 30, whereas the information relating to hysteresis is obtained by amplitude detector 36 after extracting with a high pass filter 38 and is used as input B to the circuit 30 for generating maximum and minimum levels.

Examples of a simple low and high pass filters are illustrated in FIG. 1b and FIG. 1 as has been already mentioned.

Similarly to the system presented in FIG. 1a, a circuit 30 in the embodiment shown in FIG. 2 comprises an adder-subtractor and is used to get Vₘₐₓ and Vₘᵢₙ based on the transition voltage and on the hysteresis value. The hysteresis value supplied to the circuit 30 is increased by an amplifier 37 in order to get required margin which will be defined by the amplification coefficient K. The obtained Vₘₐₓ and Vₘᵢₙ are supplied using buffers 33 and 32 to the transistors 45 and 46.

A main receiver 44 is integrated within a receiving circuit 26 and generates a terminating voltage. That circuit 26 comprises additionally a ring oscillator consisting of a receiver 41, resistor 42 and capacitor 43, and a low pass filter 49 which function in the same manner as explained with reference to FIG. 1.

Generally, the driver in any of these systems moves the output signal from a value of Vₘᵢₙ or Vₘᵢₙ minus a safety margin, to Vₘₐₓ or Vₘₐₓ plus a safety margin. This eliminates the need for a saturated signal, reduces greatly the energy needed to create and transmit a signal from one system to another, and increases the maximum frequency data that can be transmitted from the driver to the receiver.

It shall be also appreciated that, in addition to the present invention enabling high speed point to point communications, the invention can also operate in a bus environment where there may be more than one master and more than one slave. In the case where one master must drive more than one slaves, the master may interrogate each of the slaves using control bits or control protocol to determine which of the slaves respond. The maximum setpoint is taken from the slave with the maximum input level, and the minimum level from the slave with the minimum level.

I claim:

1. A communication system comprising:
a driving circuit comprising a driver with controlled output voltage or current levels; and
a receiving circuit comprising a main receiver having at least one channel for receiving main signal, wherein the receiving circuit further provides a feedback to the driver to adjust the parameters of the driver to the receiver's characteristics.

2. The communication system according to claim 1, wherein the feedback comprises a circuit capable of reproducing one or more characteristics of the main receiver.

3. The communication system according to claim 2, wherein the reproducing circuit comprises an auxiliary receiver.

4. The communication system according to claim 1, wherein the receiver's characteristics include the hysteresis.

5. The communication system according to claim 1, wherein the receiver's characteristics include the reference voltage.

6. The communication system according to claim 2, wherein the reproducing circuit is used to obtain information on the main receiver.

7. The communication system according to claim 2, wherein the reproducing circuit includes a ring oscillator circuit, the signal from the ring oscillator being used to adjust the parameters of the driver to the receiver's characteristics.

8. The communication system according to claim 3, wherein the auxiliary receiver is made on the same integrated circuit or an integrated circuit identical to the integrated circuit used to make the main receiver.

9. The communication system according to claim 5, wherein the auxiliary receiver is used to obtain the terminating voltage and reference voltage.

10. A communication system comprising:
a driving circuit comprising a driver with controlled output voltage or current levels, and
a receiving circuit comprising a main receiver having at least one channel for receiving a main signal, wherein
the driving circuit comprises an auxiliary circuit representing characteristics of the main receiver.

11. The communication system according to claim 10, wherein the auxiliary circuit comprises a copy of the main receiver.

12. The communication system according to claim 10, wherein the auxiliary circuit is made on an integrated circuit identical to the integrated circuit used to make the main receiver.

13. The communication system according to claim 10, wherein the auxiliary circuit is used to obtain information on the main receiver.

14. The communication system according to claim 13, wherein the information on the main receiver includes, but is not limited to the terminating voltage and reference voltage.

15. The communication system according to claim 10, wherein al signal generated by said auxiliary circuit is used to adjust the parameters of the driver to the receiver's characteristics.

16. In a communication system, a receiver generating a signal representing parameters bearing information on the maximum and minimum levels that are needed to cause a signal to be received as a logical one and as a logical zero whereby this signal influences the signal swing of the transmitter.

17. The receiver according to claim 16, wherein the levels are voltage levels.

18. The receiver according to claim 16, wherein the levels are current levels in current mode devices.

19. The receiver according to claim 16, wherein the signal is digital.

20. The receiver according to claim 16, wherein the signal is a differential analogue signal.

21. A method of low swing communication comprising the steps of:
providing voltage or current levels at the driver for driving a communication circuit;
generating a signal at the receiver indicative of parameters bearing information on the said voltage or current levels to cause a signal to be received as a logical one and as a logical zero;
wherein the output signal swing of the driver is adjusted using the signal generated by the receiver.

22. A method according to claim 21, wherein the output swing of the driver is adjusted to the receiver's hysteresis.

23. A method according to claim 21, wherein the terminating voltage is adjusted to the receiver's transition voltage.

24. A method according to claim 21, further comprising the use of another receiver to adjust the driver with respect to hysteresis, reference voltage, or a combination of both these features.

25. A method of low swing communicating comprising the steps of:
providing voltage or current levels at the driver for driving a communication circuit;
generating a signal at the driver representing parameters bearing information on the said voltage or current levels to cause a signal to be received as a logical one and as a logical zero;
wherein the output signal swing of the driver is adjusted using the signal bearing information on the said voltage or current levels.

26. A method according to claim 25, wherein the output swing of the driver is adjusted to the receiver's hysteresis.

27. A method according to claim 25, further comprising the use of another receiver located at the driver to adjust the driver with respect to hysteresis, reference voltage, or a combination of both these features.

28. A method of adjustment of the output signal of a driver, comprising the steps of:
providing voltage or current levels at the driver for driving a communication circuit;
generating a signal at the receiver indicative of parameters bearing information on the said voltage or current levels to cause a signal to be received as a logical one and as a logical zero;
wherein the output signal swing of the driver is adjusted using the signal generated by the receiver or the signal bearing information on the said voltage or current levels.
